(19) United States
(12) Patent Application Publication
(10) Pub. No.: US 2011/0215504 A1
(43) Pub. Date: Sep. 8, 2011

(54) TRANSFER METHOD AND TRANSFER APPARATUS

(75) Inventors: Tetsuya Imai, Ichihara (JP); Kazunobu Hashimoto, Kawasaki (JP)

(73) Assignee: PIONEER CORPORATION, Kawasaki-shi, Kanagawa (JP)

(21) Appl. No.: 13/121,068

(22) PCT Filed: Nov. 27, 2008
(86) PCT No.: PCT/JP2008/071560

§ 371 Date: May 24, 2011

(51) Int. Cl. B29C 59/02

(52) U.S. Cl. 264/293; 425/385

(57) ABSTRACT

A first mold having an uneven pattern formed thereon and a second mold having an uneven pattern formed thereon are fixed in a state in which reference positions of the first mold and the second mold are aligned with the center axis of support means. An object to which transfer is to be performed is made supported by the support means, and the first mold is made move toward the second mold in a state in which a reference position of the object is aligned with the center axis of the support means so that the first mold is pressed to a first surface of the object and, at the same time, the second mold is pressed to a second surface of the object.

### TECHNICAL FIELD

The present invention relates to a transfer method and a transfer apparatus to transfer an uneven pattern to an object to which transfer is to be performed.

### RELATED ART

In recent years, there has been proposed an apparatus as shown in FIG. 1 of Patent document 1, for example, as an example of a transfer apparatus to transfer a micro uneven pattern to a magnetic recording media substrate. In such a transfer apparatus, in the first place, reference positions of a mold and a substrate having a transfer layer formed thereon are aligned with each other in a state in which the mold and the substrate are spaced apart from each other, and then the mold is pressed to the transfer layer formed at the substrate.

In the conventional transfer apparatus, however, an object to which transfer is to be performed and a mold are simultaneously supported by a conical mandrel only with the result that, when the mold is pressed to or released from the object, the mold and/or the object may be supported by a portion of the conical mandrel located at a position different than a predetermined position of the conical mandrel. Furthermore, if the mold and the object are bent to different degrees, for example, the positions of the mold and/or the object may vary due to such bending. As a result, transfer is performed in a state in which the reference positions of the mold and the object are misaligned with each other. Also, during a transfer process, the mold and/or the object may be damaged.
Patent document 1: Japanese Patent Application Publication No. 2005-529436

### DISCLOSURE OF THE INVENTION

### Problems to be Solved by the Invention

The present invention has been made in view of the above problems, and it is an object of the present invention to provide a transfer method and a transfer apparatus which prevent misalignment in reference positions of a mold having an uneven pattern formed thereon and an object to which transfer is to be performed, thereby achieving high-precision pattern transfer.

### Means to Solve the Problems

In accordance with a first aspect of the present invention, there is provided a transfer method to press a first mold to a first surface of an object to which transfer is to be performed and to press a second mold to a second surface of the object, the transfer method including a first process of making the first mold supported by support means held by a first mold holding part, a second process of making the second mold supported by the support means held by a second mold holding part, a third process of making the first mold pressed to the first surface of the object supported by the support means, and a fourth process of making the second mold pressed to the second surface of the object.

Also, in accordance with a second aspect of the present invention, there is provided a transfer method to press a first mold having an uneven pattern at the surface thereof to a first surface of an object to which transfer is to be performed and to press a second mold having an uneven pattern at the surface thereof to a second surface of the object, the transfer method including a first supporting process of making the first mold supported by support means, a first holding process of making a first mold holding part move in a first direction to make the first mold held by the first mold holding part, a first moving process of making the first mold holding part move in a second direction opposite to the first direction, a second supporting process of making the second mold supported by the support means, a second holding process of making the support means move in the first direction to make the second mold held by a second mold holding part, an object supporting process of supporting the object of the support means, a pressing process of making the first mold holding part move in the first direction to make the first mold and the second mold pressed to both surfaces of the object, a first releasing process of making the first mold holding part move in the second direction to make the first mold and the object released from each other, and a second releasing process of making the support means move in the second direction to make the second mold and the object released from each other.

Also, in accordance with a third aspect of the present invention, there is provided a transfer method to make support means penetrate through holes formed at center positions of an object to which transfer is to be performed, a first mold and a second mold so that the object, the first mold and the second mold are aligned with each other, to press the first mold to a first surface of the object and to press the second mold to a second surface of the object, wherein the center position of the object is aligned with the support means after the center positions of the first mold and the second mold are aligned with the support means.

Also, in accordance with the present invention, there is provided a transfer apparatus to press a first mold to a first surface of an object to which transfer is to be performed and to press a second mold to a second surface of the object, the transfer apparatus including support means to support the object, the first mold and the second mold, first mold holding means to hold the first mold supported by the support means, second mold holding means to hold the second mold supported by the support means, and press drive means to make the first mold pressed to the first surface of the object supported by the support means and to make the second mold pressed to the second surface of the object.

### BRIEF DESCRIPTION OF THE DRAWINGS

FIG. 1 is a view illustrating the schematic construction of an imprint apparatus according to the present invention.

FIG. 2 is a view illustrating the construction of a center pin 30b shown in FIG. 1.

FIG. 3 is a view illustrating an installed state of the center pin 30b.

FIG. 4 is a flow chart illustrating an imprint process.

FIG. 5 is a flow chart illustrating the imprint process.

FIG. 6 is a series of views typically illustrating respective states of (respective positional relations between) an upper mold holding part 501a, a lower mold holding part 501b and the center pin 30b at respective steps of a pattern transfer operation.

FIG. 7 is a series of views typically illustrating respective states of (respective positional relations between) the upper mold holding part 501a, the lower mold holding part 501b and the center pin 30b at respective steps of the pattern transfer operation.

FIG. 8 is a series of views typically illustrating respective states of (respective positional relations between) the upper mold holding part 501a, the lower mold holding part 501b and the center pin 30b at respective steps of the pattern transfer operation.

FIG. 9 is a series of views illustrating an example of a process for manufacturing a double-sided magnetic disk.

FIG. 10 is a view illustrating another construction of the center pin 30b.

FIG. 11 is a view illustrating yet another construction of the center pin 30b.

FIG. 12 is a view illustrating the operation of a first pin end PB_{S1} shown in FIG. 11.

FIG. 13 is a view illustrating a modification of the center pin 30b shown in FIG. 11.

### BEST MODE FOR CARRYING OUT THE INVENTION

A first mold having an uneven pattern formed thereon and a second mold having an uneven pattern formed thereon are fixed in a state in which reference positions of the first mold and the second mold are aligned with the center axis of a center pin. An object to which transfer is to be performed is supported by the center pin, and the first mold is moved toward the second mold in a state in which a reference position of the object is aligned with the center axis of the center pin so that the first mold is pressed to a first surface of the object and, at the same time, the second mold is pressed to a second surface of the object.

Hereinafter, embodiments of the present invention will be described in detail with reference to the accompanying drawings. It should be noted, however, that the scope of the present invention is not limited by the illustrated embodiments.

### Embodiments

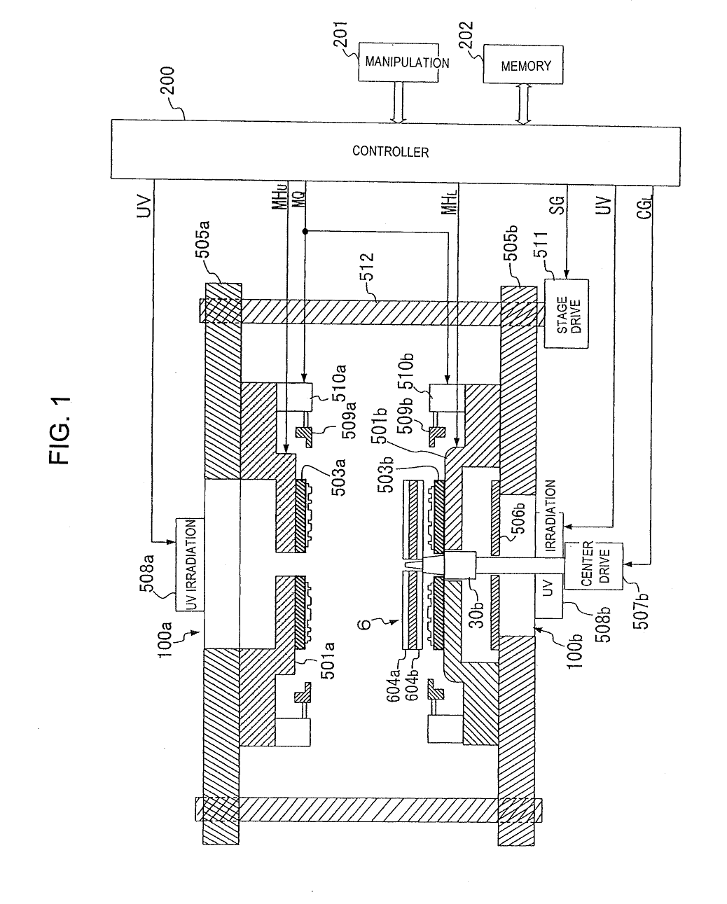

FIG. 1 is a sectional view illustrating the schematic construction of an ultraviolet (UV) type imprint apparatus that performs a pattern transfer operation using an imprint method according to the present invention.

The imprint apparatus transfers a pattern to opposite sides of an object to which transfer is to be performed, specifically an object, such as a substrate 6, to which a pattern is to be transferred, using an upper mold 503a having an uneven pattern to be transferred and a lower mold 503b having an uneven pattern to be transferred. In this specification, an object to which a pattern is to be transferred is referred to as a substrate. The substrate includes transfer layers. An upper transfer layer 604a made of a transfer material which is cured when ultraviolet rays are irradiated thereto and a lower transfer layer 604b made of a transfer material which is cured when ultraviolet rays are irradiated thereto are formed at the opposite sides of the substrate 6. Meanwhile, FIG. 1 illustrates the construction of the imprint apparatus in which the upper mold 503a and the lower mold 503b are disposed at the substrate 6.

The imprint apparatus shown in FIG. 1 includes an upper mechanism portion, a lower mechanism portion, a controller 200 having a central processing unit (CPU) to control the upper mechanism portion and the lower mechanism portion, a manipulation portion 201, and a memory 202 to store an imprint process program, which will be described below.

The upper mechanism portion includes an upper mold holding part 501a, an upper stage 505a, an upper UV irradiation unit 508a, an upper mold gripping part 509a and an upper mold gripping drive unit 510a.

As shown in FIG. 1, an opening 100a and screw holes having screw grooves, into which ball screws 512, which will be described below, are threadedly engaged, are formed at the upper stage 505a, which is formed in the shape of a board.

The upper UV irradiation unit 508a is disposed at the top of the upper stage 505a. The upper mold holding part 501a, which is made of a transparent material, is disposed at the bottom of the upper stage 505a. In addition, the upper mold gripping drive unit 510a is disposed at the periphery of the upper mold holding part 501a. The upper mold holding part 501a has a mold holding surface (in FIG. 1, a surface which the upper mold 503a is in contact with) to hold the upper mold 503a.

The upper UV irradiation unit 508a projects ultraviolet rays to cure a transfer material to the upper transfer layer 604a of the substrate 6 via the opening 100a and the upper mold holding part 501a according to an ultraviolet irradiation signal UV provided from the controller 200.

The upper mold holding part 501a holds the upper mold 503a at the mold holding surface, for example, by vacuum lifting according to an upper mold holding signal MH_{U} provided from the controller 200. Meanwhile, the upper mold 503a may be held by the mold holding surface using a mechanical method instead of vacuum lifting.

The upper mold holding drive unit 510a drives the upper mold gripping part 509a according to a mold gripping signal MQ provided from the controller 200 so that the edge of the upper mold 503a can be gripped by the upper mold gripping part 509a, which is formed in an L shape.

The lower mechanism portion of the imprint apparatus includes a center pin 30b, a lower mold holding part 501b, a lower stage 505b, a center pin support part 506b, a lower center pin drive unit 507b, a lower UV irradiation unit 508b, a lower mold gripping part 509b, a lower mold gripping drive unit 510b, a stage upward and downward drive unit 511 and ball screws 512.

As shown in FIG. 1, an opening 100b and through holes, through which the ball screws 512 extend, are formed at the lower stage 505b, which is formed in the shape of a board. One end of each of the ball screws 512 extends through a corresponding one of the through holes of the lower stage 505b and the other end of each of the ball screws 512 is threadedly engaged into a corresponding one of the screw holes of the upper stage 505a so that the ball screws 512 connect the lower stage 505b and the upper stage 505a to each other while maintaining a state in which the lower stage 505b and the upper stage 505a are in parallel to each other.

The stage upward and downward drive unit 511 rotates the ball screws 512 in a clockwise direction or in a counterclockwise direction according to a stage drive signal SG provided from the controller 200 to move the upper stage 505a upward or downward in a state in which the upper stage 505a is parallel to the lower stage 505b. That is, the upper mold holding part 501a moves away from the lower mold holding part 501b in the direction perpendicular to the mold holding surface of the lower mold holding part 501b by upward movement of the upper stage 505a. Upon downward movement of the upper stage 505a, on the other hand, the upper mold holding part 501a moves toward the lower mold holding part 501b.

The center pin support part 506b is disposed in the opening 100b of the lower stage 505b at the top of the lower stage 505b. Furthermore, the lower mold holding part 501b, which is made of a transparent material, is disposed at the top of the lower stage 505b. In addition, the lower mold gripping drive unit 510b is disposed at the periphery of the lower mold holding part 501b.

The lower mold holding part 501b has a mold holding surface (in FIG. 1, a surface which the lower mold 503b is in contact with) to hold the lower mold 503b. Also, through holes, through which the center pin 30b is supported in a state in which the center pin 30b can be moved in the direction perpendicular to the mold holding surface of the lower mold holding part 501b, are formed at the center of the lower mold holding part 501b and at the center of the center pin support part 506b.

The lower mold holding part 501b holds the lower mold 503b at the mold holding surface, for example, by vacuum lifting according to a lower mold holding signal MH_{L} provided from the controller 200. Meanwhile, the lower mold 503b may be held by the mold holding surface using a mechanical method instead of vacuum lifting.

The lower mold gripping drive unit 510b drives the lower mold gripping part 509b according to a mold gripping signal MQ provided from the controller 200 so that the edge of the lower mold 503b can be gripped by the lower mold gripping part 509b, which is formed in an L shape.

The lower UV irradiation unit 508b projects ultraviolet rays to cure a transfer material to the lower transfer layer 604b of the substrate 6 via the opening 100b and the lower mold holding part 501b according to an ultraviolet irradiation signal UV provided from the controller 200.

The center pin drive unit 507b moves the center pin 30b upward or downward in the direction perpendicular to the mold holding surface of the lower mold holding part 501b, i.e. in the center axial direction of the center pin 30b, according to a center pin movement signal CG_{L} provided from the controller 200.

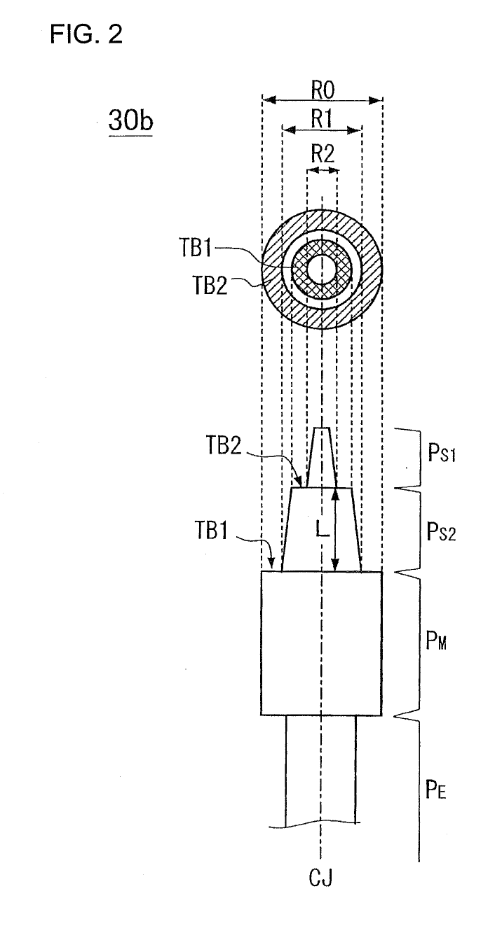

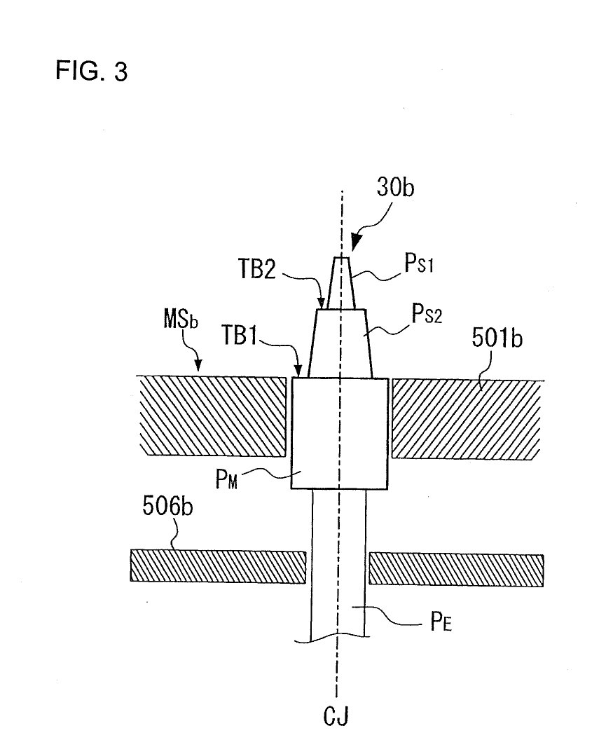

FIG. 2 is a detailed view illustrating the shape of the center pin 30b, and FIG. 3 is an enlarged view of the center pin 30b and the center pin support part 506b.

As shown in FIG. 2, the center pin 30b includes a cylindrical pin end part P_{E}, a cylindrical pin middle part P_{M}, a first truncated conical pin tip end part P_{S1} and a second truncated conical pin tip end part P_{S2}. As shown in FIG. 2, the height of the second pin tip end part P_{S2} is greater than the thickness of the substrate 6, and the diameter R1 of the second pin tip end part P_{S2} at the bottom thereof is less than the diameter R0 of the pin middle part P_{M}. The diameter R2 of the first pin tip end part P_{S1} at the bottom thereof is less than the diameter of the second pin tip end part P_{S2} at the top thereof. Also, the diameter R1 of the second pin tip end part P_{S2} at the bottom thereof is equal to the diameter of center holes formed at the center positions (the reference positions) of the upper mold 503a and the lower mold 503b. The diameter R2 of the first pin tip end part P_{S1} at the bottom thereof is equal to the diameter of a center hole formed at the center position (the reference position) of the substrate 6. At the top of the pin middle part P_{M}, the peripheral region of the bottom of the second pin tip end part P_{S2} constitutes a first support part TB1 to support the upper mold 503a and the lower mold 503b. At the top of the second pin tip end part P_{S2}, the peripheral region of the bottom of the first pin tip end part P_{S1} constitutes a second support part TB2 to support the substrate 6. Here, the diameter of the pin end part P_{E} is less than the diameter R0 of the pin middle part P_{M}, and the diameter of the through hole formed at the center pin support part 506b is equal to the diameter of the pin end part P_{E}.

Also, as shown in FIG. 3, the center pin 30b is supported so that the center axis CJ of the center pin 30b is perpendicular to the mold holding surface MSb of the lower mold holding part 501b in a state in which the pin end part P_{E} of the center pin 30b extends through the through hole of the center pin support part 506b.

In order to operate the imprint apparatus, the manipulation unit 201 receives various operation commands from a user and provides operation command signals indicating the respective operation commands to the controller 200. The controller 200 performs an operation process program corresponding to the operation command signals provided from the manipulation unit 301 to generate various control signals UV, CG_{U}, CG_{L} and MH to control the imprint apparatus.

Here, when the manipulation unit 201 receives an imprint execution command from a user, the controller 200 reads an imprint process program stored in the memory 202 and starts to execute the read imprint process program.

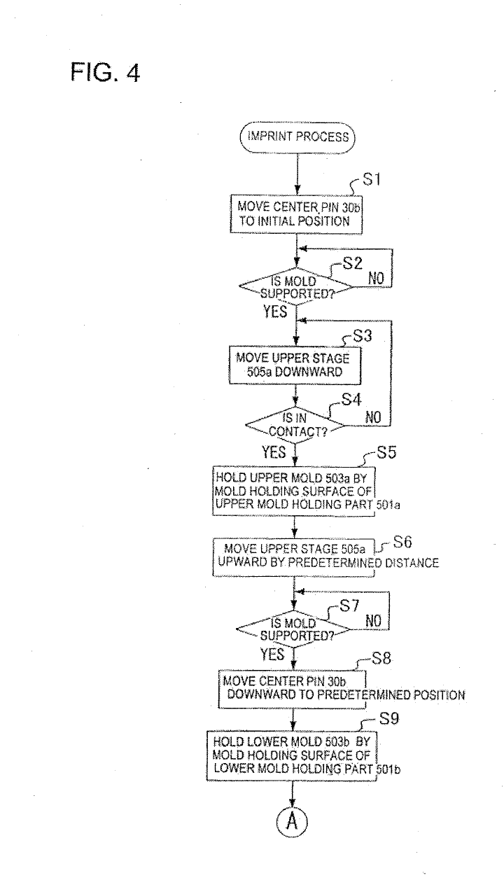

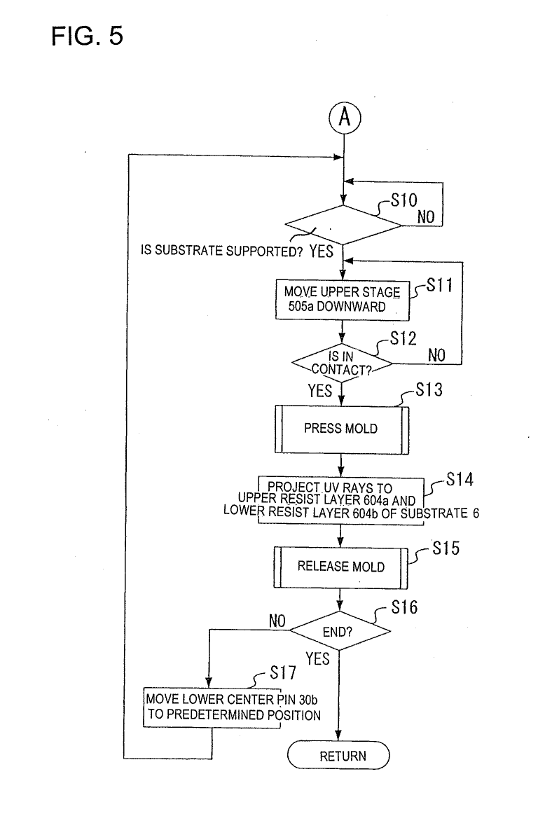

FIGS. 4 and 5 are flow charts illustrating an imprint process program.

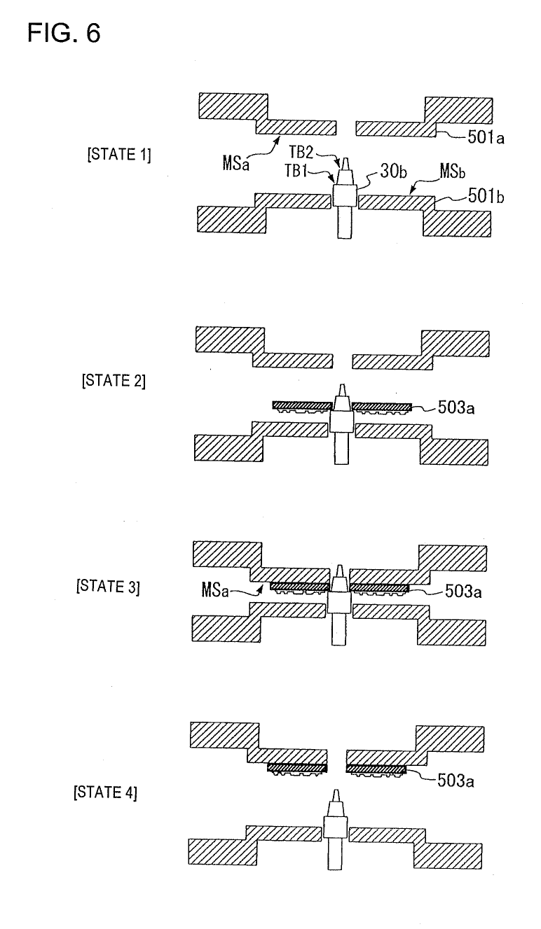

Hereinafter, an imprint transfer operation performed through the execution of the imprint process program will be described with reference to FIGS. 6 to 8. Meanwhile, FIGS. 6 to 8 typically show respective states of (respective positional relations between) the upper mold holding part 501a, the lower mold holding part 501b and the center pin 30b of the imprint apparatus shown in FIG. 1 at respective steps of the imprint transfer operation.

Referring to FIG. 4, first, the controller 200 provides a center pin movement signal CG_{L} to the center pin drive unit 507b so as to move the center pin 30b to a predetermined initial position (Step S1). As the result of the execution of Step S1, the center pin drive unit 507b moves the center pin 30b to an initial position as shown in [State 1] of FIG. 6, i.e. a position at which both the first support part TB1 and the second support part TB2 of the center pin 30b are located higher than the mold holding surface MSb of the lower mold holding part 501b.

Subsequently, the controller 200 repeatedly determines whether the center pin 30b supports the upper mold 503a until the upper mold 503a is supported by the center pin 30b (Step S2). Here, a mold conveyance apparatus (not shown) mounts the upper mold 503a to the center pin 30b so that, as previously described, the center pin 30b extends through the center hole of the upper mold 503a. As a result, the upper mold 503a is supported by the first support part TB1 of the center pin 30b in a state in which a pattern surface of the upper mold 503a faces downward as shown in [State 2] of FIG. 6.

When it is determined at Step S2 that the upper mold 503a is supported by the center pin 30b as shown in [State 2] of FIG. 6, the controller 200 provides a stage drive signal SG to the stage upward and downward drive unit 511 so as to move the upper stage 505a downward (Step S3). As the result of the execution of Step S3, the entire upper mechanism portion, including the upper mold holding part 501a, is slowly moved downward.

Subsequently, the controller 200 determines whether the mold holding surface of the upper mold holding part 501a is in contact with the upper mold 503a (Step S4). When it is determined at Step S4 that the mold holding surface of the upper mold holding part 501a is not in contact with the upper mold 503a, the procedure returns to Step S3 and the controller 200 performs the above-described operations again. That is, the upper mold holding part 501a is moved downward until the mold holding surface MSa of the upper mold holding part 501a comes into contact with the upper mold 503a as shown in [State 3] of FIG. 6.

When it is determined at Step S4 that the mold holding surface of the upper mold holding part 501a is in contact with the upper mold 503a as shown in [State 3] of FIG. 6, the controller 200 provides an upper mold holding signal MH_{U} to the upper mold holding part 501a (Step S5). As the result of the execution of Step S5, the upper mold 503a is held by the mold holding surface of the upper mold holding part 501a. Meanwhile, at Step S5, the controller 200 may provide a mold gripping signal MQ to the upper mold gripping drive unit 510a so that the edge of the upper mold 503a is gripped by the upper mold gripping part 509a.

That is, as the result of the execution of Step S1 to Step S5, the upper mold 503a is held by the mold holding surface of the upper mold holding part 501a in a state in which the center position (the reference position) of the upper mold 503a is aligned with the center axis of the center pin 30b.

Subsequently, the controller 200 provides a stage drive signal SG to the stage upward and downward drive unit 511 so as to move the upper stage 505a upward by a predetermined distance (Step S6). As the result of the execution of Step S6, the upper mold holding part 501a is moved upward in the center axial direction of the center pin 30b as shown in [State 4] of FIG. 6. Consequently, the upper mold 503a is separated from the center pin 30b.

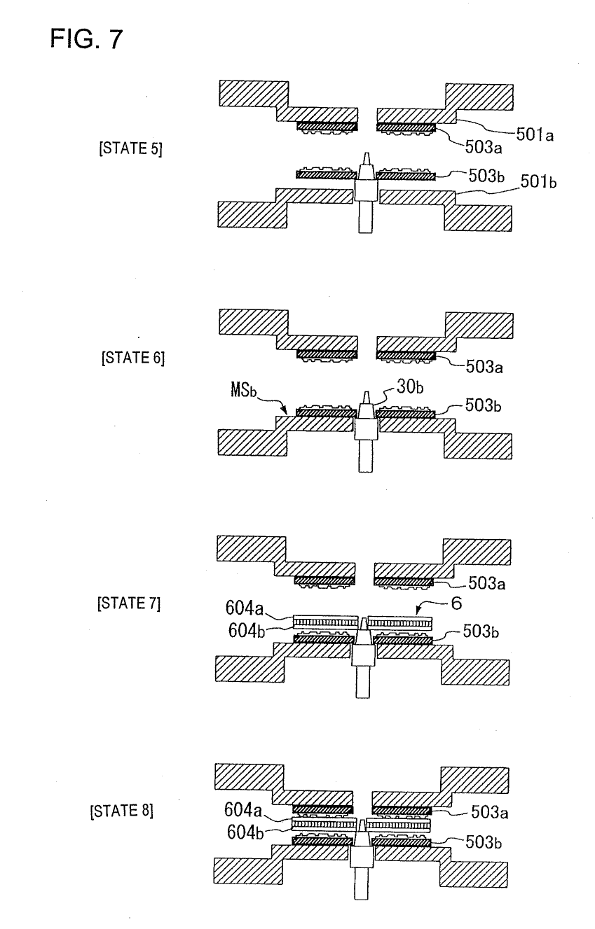

Subsequently, the controller 200 repeatedly determines whether the center pin 30b supports the lower mold 503b until the lower mold 503b is supported by the center pin 30b (Step S7). Here, the mold conveyance apparatus mounts the lower mold 503b to the center pin 30b so that, as previously described, the center pin 30b extends through the center hole of the lower mold 503b. As a result, the lower mold 503b is supported by the first support part TB1 of the center pin 30b in a state in which a pattern surface of the lower mold 503b faces upward as shown in [State 5] of FIG. 7.

When it is determined at Step S7 that the lower mold 503b is supported by the center pin 30b as shown in [State 5] of FIG. 7, the controller 200 provides a center pin movement signal CG_{L} to the center pin drive unit 507b so as to move the center pin 30b downward to the predetermined position as shown in FIG. 3 (Step S8). As the result of the execution of Step S8, the center pin drive unit 507b moves the center pin 30b to the predetermined position. That is, the center pin drive unit 507b moves the center pin 30b downward until the first support part TB1 of the center pin 30b and the mold holding surface MSb of the lower mold holding part 501b are placed on the same plane as shown in [State 6] of FIG. 7. As a result, the lower mold 503b is supported by the mold holding surface MSb of the lower mold holding part 501b as shown in [State 6] of FIG. 7.

Subsequently, the controller 200 provides a mold holding signal MH_{L} to the lower mold holding part 501b (Step S9). As the result of the execution of Step S9, the lower mold 503b is held by the mold holding surface MSb of the lower mold holding part 501b. Meanwhile, at Step S9, the controller 200 may provide a mold gripping signal MQ to the lower mold gripping drive unit 510b so that the edge of the lower mold 503b is gripped by the lower mold gripping part 509b.

That is, as the result of the execution of Step S7 to Step S9, the lower mold 503b is held by the mold holding surface of the lower mold holding part 501b in a state in which the center position (the reference position) of the lower mold 503b is aligned with the center axis of the center pin 30b.

Subsequently, the controller 200 repeatedly determines whether the substrate 6 is supported by the center pin 30b until the substrate 6 is supported by the center pin 30b (Step S10). Here, the mold conveyance apparatus (not shown) mounts the substrate 6 to the center pin 30b so that, as previously described, the center pin 30b extends through the center hole of the substrate 6. As a result, the substrate 6 is supported by the second support part TB2 of the center pin 30b as shown in [State 7] of FIG. 7.

When it is determined at Step S10 that the substrate 6 is supported by the center pin 30b as shown in [State 7] of FIG. 7, the controller 200 provides a stage drive signal SG to the stage upward and downward drive unit 511 so as to move the upper stage 505a downward (Step S11). As the result of the execution of Step S11, the upper mold holding part 501a is moved downward in the center axial direction of the center pin 30b.

Subsequently, the controller 200 determines whether the upper mold 503a is in contact with the substrate 6 (Step S12). When it is determined at Step S12 that the upper mold 503a is not in contact with the substrate 6, the procedure returns to Step S11 and the controller 200 performs the above-described operations again. That is, the upper mold holding part 501a is moved downward until the upper mold 503a comes into contact with the substrate 6 as shown in [State 8] of FIG. 7.

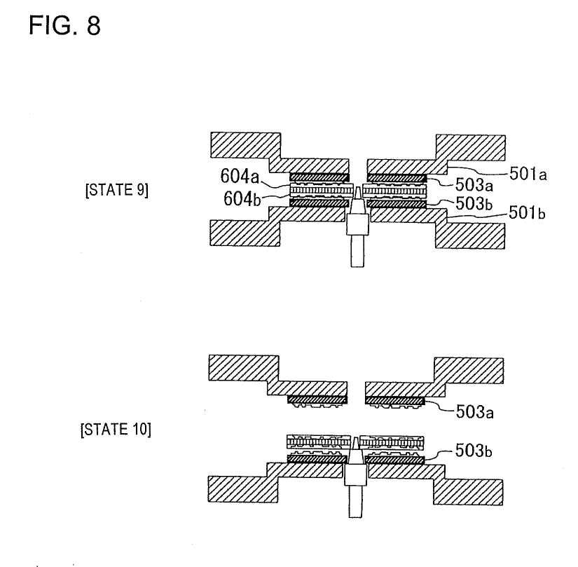

When it is determined at Step S12 that the upper mold 503a is in contact with the substrate 6, the controller 200 performs a mold pressing operation so as to press the upper mold 503a and the lower mold 503b to the substrate 6 (Step S13). In order to perform the mold pressing operation, the controller 200 first provides a stage drive signal SG to the stage upward and downward drive unit 511 so as to move the upper stage 505a downward so that the upper mold 503a and the lower mold 503b are pressed to the substrate 6 at a predetermined pressing value PV_{AD}. As the result of providing the stage drive signal SG for a predetermined time, opposite sides of the substrate 6 are pressed by the upper mold 503a and the lower mold 503b as shown in [State 9] of FIG. 8, and this state is maintained for the predetermined time. Consequently, an uneven pattern formed at the upper mold 503a is pressed to the upper transfer layer 604a and, at the same time, an uneven pattern formed at the lower mold 503b is pressed to the lower transfer layer 604b. Since the upper transfer layer 604a and the lower transfer layer 604b are in a liquid state (in a mobile state), the upper transfer layer 604a is deformed in correspondence to the shape of the uneven pattern formed at the upper mold 503a and, at the same time, the lower transfer layer 604b is deformed in correspondence to the shape of the uneven pattern formed at the lower mold 503b. Meanwhile, conditions, such as pressure at which the upper mold 503a and the lower mold 503b are pressed to the substrate 6 and time during which the upper mold 503a and the lower mold 503b are pressed to the substrate 6, may be appropriately set based on shapes of the uneven patterns of the upper mold 503a and the lower mold 503b and transfer materials for the upper transfer layer 604a and the lower transfer layer 604b.

After the execution of Step S13, the controller 200 provides an ultraviolet irradiation signal UV to the upper UV irradiation unit 508a and the lower UV irradiation unit 508b (Step S14). As the result of the execution of Step S14, the upper UV irradiation unit 508a projects ultraviolet rays to the upper transfer layer 604a of the substrate 6 so as to harden the upper transfer layer 604a and, at the same time, the lower UV irradiation unit 508b projects ultraviolet rays to the lower transfer layer 604b of the substrate 6 so as to harden the lower transfer layer 604b. Consequently, the upper transfer layer 604a and the lower transfer layer 604b are hardened with the result that the uneven patterns are settled on the surfaces of the upper transfer layer 604a and the lower transfer layer 604b.

Subsequently, the controller 200 performs a release operation to release the substrate 6 from the upper mold 503a and the lower mold 503b (Step S15). In order to perform the release operation, the controller 200 provides a stage drive signal SG to the stage upward and downward drive unit 511 so as to move the upper stage 505a upward by a predetermined distance. As a result, the upper mold 503a is released from the upper transfer layer 604a of the substrate 6 as shown in [State 10] of FIG. 8. At this time, the substrate 6 may be pressed by a fixing member (not shown) so that the substrate 6 and the upper mold 503a are prevented from moving along with the upper mold 503a in a state in which the substrate 6 and the upper mold 503a are in tight contact with each other. In addition, the center pin 30b is moved upward with the result that the substrate 6 is released from the lower mold 503b. Meanwhile, the upper stage 505a and the center pin 30b may be moved simultaneously. In this case, it is possible to simultaneously release the upper mold 503a and the lower mold 503b from the substrate 6 since the rising speed of the upper stage 505a is higher than that of the center pin 30b. As a result, an uneven pattern that is the inverse of the uneven pattern formed at the upper mold 503a is formed at the surface of the upper transfer layer 604a. On the other hand, an uneven pattern that is the inverse of the uneven pattern formed at the lower mold 503b is formed at the surface of the lower transfer layer 604b. That is, as the result of the execution of Step S13 to Step S15, the patterns formed at the upper mold 503a and the lower mold 503b are transferred to the upper transfer layer 604a and the lower transfer layer 604b of the substrate 6. Afterwards, the controller 200 transmits a command to separate the substrate 6 from the center pin 30b to the substrate conveyance apparatus.

Subsequently, the controller 200 determines whether an operation command signal to indicate termination of the operation has been provided from the manipulation unit 201 (Step S16). When it is determined at Step S16 that the operation command signal to indicate the termination of the operation has been provided from the manipulation unit 201, the controller 200 terminates the imprint process program. On the other hand, when it is determined at Step S16 that the operation command signal to indicate the termination of the operation has not been provided from the manipulation unit 201, the controller 200 waits until the substrate conveyance apparatus separates the substrate supported by the center pin 30b from the center pin 30b and then provides a center pin movement signal CG_{L} to the center pin drive unit 507b so as to move the center pin 30b to a predetermined position to support the substrate 6 as shown in [State 6] of FIG. 7 (Step S17). Upon completion of Step S17, the procedure returns to Step S10 and the controller 200 repeatedly performs the above-described operations. Consequently, pattern transfer is continuously performed with respect to a newly supported substrate 6.

In the imprint apparatus shown in FIG. 1, as described above, first, the upper mold 503a is supported by the first support part TB1 of the center pin 30b so that the center position (the reference position) of the upper mold 503a is aligned with the center axis of the center pin 30b, and, in this state, the upper mold 503a is held by the upper mold holding part 501a (State 1 to State 3). Subsequently, the upper mold holding part 501a, by which the upper mold 503a is held, is moved upward in the center axial direction of the center pin 30b so that the upper mold 503a is separated from the center pin 30b (State 4). Subsequently, the lower mold 503b is supported by the first support part TB1 of the center pin 30b so that the center position (the reference position) of the lower mold 503b is aligned with the center axis of the center pin 30b, and, in this state, the lower mold 503b is held by the lower mold holding part 501b (State 5 and State 6). Subsequently, the substrate 6 is supported by the second support part TB2 of the center pin 30b so that the center position (the reference position) of the substrate 6 is aligned with the center axis of the center pin 30b (State 7). As a result, all of the center positions (the reference positions) of the substrate 6, the upper mold 503a and the lower mold 503b are aligned with the center axis of the center pin 30b. Subsequently, the upper mold holding part 504a, by which the upper mold 503a is held, is moved downward to the lower mold 503b in the center axial direction of the center pin 30b so that the upper mold 503a is pressed to the upper transfer layer 604a of the substrate 6 and, at the same time, the lower mold 503b is pressed to the lower transfer layer 604b of the substrate 6, and ultraviolet rays from the upper UV irradiation unit 508a are irradiated to the upper transfer layer 604a of the substrate 6 so as to harden the upper transfer layer 604a of the substrate 6 and, at the same time, ultraviolet rays from the lower UV irradiation unit 508b are irradiated to the lower transfer layer 604b of the substrate 6 so as to harden the lower transfer layer 604b of the substrate 6 (State 8 and State 9). Consequently, the uneven pattern that is the inverse of the uneven pattern formed at the upper mold 503a is transferred to the upper transfer layer 604a of the substrate 6 and, at the same time, the uneven pattern that is the inverse of the uneven pattern formed at the lower mold 503b is transferred to the lower transfer layer 604b of the substrate 6.

That is, in the imprint apparatus shown in FIG. 1, first, the upper mold 503a is held by the upper mold holding part 501a in a state in which the reference position of the upper mold 503a is aligned with the center axis of the center pin 30b, and the upper mold holding part 501a is moved in the center axial direction of the center pin 30b so that the upper mold 503a is separated from the center pin 30b. Subsequently, the lower mold 503b is held by the lower mold holding part 501b in a state in which the reference position of the lower mold 503b is aligned with the center axis of the center pin 30b. Afterwards, the substrate 6 is supported by the center pin 30b, and the upper mold holding part 501a is moved toward the lower mold 503b in the center axial direction of the center pin 30b in a state in which the reference positions of the lower mold 503b and the substrate 6 are aligned with the center axis of the center pin 30b so that both the molds are pressed to the opposite sides of the substrate 6. Since the above pressing operation is performed in a state in which the reference positions of the upper mold 503a and the lower mold 503b are fixed, it is possible to perform high-precision pattern transfer without misalignment of the reference positions thereof although the substrate 6, the upper mold 503a and the lower mold 503b are bent. Also, since the misalignment of the molds and the substrate does not occur when the pressing operation and the releasing operation are performed as described above, it is possible to prevent damage to the molds and/or an object to which a pattern is to be transferred.

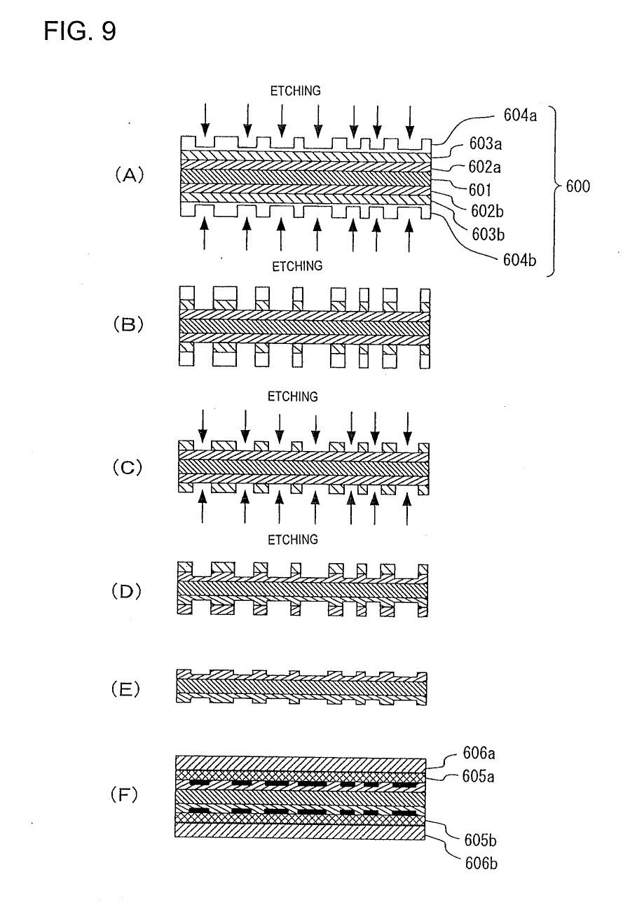

Here, the above imprint process may be applied to a process for manufacturing magnetic recording media, such as discrete track media and bit patterned media. Hereinafter, a method of manufacturing a magnetic disk including the above imprint process will be described with reference to FIG. 9.

First, an upper mold 503a and a lower mold 503b, each having a predetermined uneven pattern formed at a base material made of a material, such as glass, transmitting ultraviolet rays, are manufactured. The uneven pattern is formed, for example, by forming a resist pattern on the base material using an electron beam lithography apparatus and performing a dry etching process using the resist pattern as a mask.

The finished upper mold 503a and the finished lower mold 503b are surface treated using a silane coupling agent to improve releasability. Meanwhile, the upper mold 503a and the lower mold 503b each may be used as an original disk, and an object to which a pattern is to be transferred, which is made of a material, such as glass reproduced using an imprint method, transmitting ultraviolet rays, may be used as a mold for transfer. In addition, an object to which a pattern is to be transferred, which is made of a material, such as glass reproduced using the imprint method from the reproduced disk manufactured using the above method, transmitting ultraviolet rays, may be used as a mold for transfer. Meanwhile, if the reproduced mold for transfer is used, the base material of the original disk and/or the reproduced disk may be made, for example, of a material, such as silicon or nickel (including alloys thereof) reproduced using galvanoplastics, which does not transmit ultraviolet rays.

Subsequently, a magnetic disk media substrate (hereinafter, referred to as a media substrate) 600 is manufactured. The media substrate 600 is manufactured, for example, by stacking a plurality of layers, including an upper transfer layer 604a and a lower transfer layer 604b, which will be described below, at one surface (the upper surface) and the other surface (the bottom surface) of a circular support substrate 601 made of specially processed chemically tempered glass, silicon wafer, or an aluminum substrate. That is, as shown in FIG. 9(A), an upper nonmagnetic layer 602a made of a nonmagnetic material, an upper metal layer 603a made of a metal material, such as Ta or Ti, and an upper transfer layer 604a are stacked at the top of the support substrate 601. A lower nonmagnetic layer 602b made of a nonmagnetic material, a lower metal layer 603b made of a metal material, such as Ta or Ti, and a lower transfer layer 604b are formed at the bottom of the support substrate 601 by stacking. The upper nonmagnetic layer 602a, the upper metal layer 603a, the lower nonmagnetic layer 602b and the lower metal layer 603b are formed using a sputtering method.

Subsequently, uneven patterns formed at the upper mold 503a and the lower mold 503b are transferred to the upper transfer layer 604a and the lower transfer layer 604b formed at the media substrate 600 using the above imprint method. That is, the upper transfer 604a and the lower transfer layer 604b are formed at the media substrate 600 prepared through the above process using a spin coating method, and the upper mold 503a and the lower mold 503b are fixed in a state in which the reference positions of the upper mold 503a and the lower mold 503b are aligned with the center axis of the center pin 30b. Afterwards, the media substrate 600 is supported by the center pin 30b, and the upper mold 503a is moved toward the lower mold 503b in the center axial direction of the center pin 30b in a state in which the reference position of the media substrate 600 is aligned with the center axis of the center pin 30b so that the upper mold 503a is pressed to one side of the media substrate 600 and, at the same time, the lower mold 503b is pressed to the other side of the media substrate 600. Afterwards, ultraviolet rays from the upper UV irradiation unit 508a are irradiated to the upper transfer layer 604a of the media substrate 600 so as to harden the upper transfer layer 604a of the media substrate 600 and, at the same time, ultraviolet rays from the lower UV irradiation unit 508b are irradiated to the lower transfer layer 604b of the media substrate 600 so as to harden the lower transfer layer 604b of the media substrate 600. After the upper transfer layer 604a and the lower transfer layer 604b are hardened, the upper mold 503a and the lower mold 503b are released from the media substrate 600. Finally, the media substrate 600 is taken out. The sectional structure shown in FIG. 9(A) is formed at the opposite sides of the media substrate 600 through the above processes.

Subsequently, an etching process is performed with respect to both surfaces of the media substrate 600 having the structure as shown in FIG. 9(A). The etching process is performed as follows. The residual film remains at portions of the upper transfer layer 604a corresponding to the protruding parts of the upper mold 503a, and the residual film remains at portions of the lower transfer layer 604b corresponding to the protruding parts of the lower mold 503b. First, therefore, the residual film is removed using oxygen reactive ion etching (RIE). Subsequently, dry etching is performed using the upper transfer layer 604a and the lower transfer layer 604b patterned through the above imprint process as a mask to etch the upper metal layer 603a and the lower metal layer 603b, and patterning is performed. Through the above etching processes, as shown in FIG. 9(B), the depressed portions of the uneven patterns of the upper resist layer 604a and the lower resist layer 604b and the portions of the upper metal layer 603a and the lower metal layer 603b corresponding to the depressed portions are removed, and patterns are formed at the upper metal layer 603a and the lower metal layer 603b (a metal mask patterning process).

Subsequently, a transfer layer removal process using wet etching or dry etching is performed with respect to the opposite sides of the media substrate 600 in a state as shown in FIG. 9(B) so that the residual transfer layers are removed from the upper metal layer 603a and the lower metal layer 603b as shown in FIG. 9(C) (a transfer layer removal process).

Subsequently, an etching process using the upper metal layer 603a and the lower metal layer 603b as a mask is performed with respect to the media substrate 600 in a state as shown in FIG. 9(C) to etch the nonmagnetic bodies and to perform patterning. As a result, patterns are formed at the nonmagnetic materials of the respective exposed portions of the upper nonmagnetic layer 602a and the lower nonmagnetic layer 602b by a predetermined depth as shown in FIG. 9(D) (a nonmagnetic layer patterning process).

Subsequently, wet etching or dry etching is performed with respect to the opposite sides of the media substrate 600 in a state as shown in FIG. 9(D) to remove the residual upper metal layer 603a and the residual lower metal layer 603b so that the residual metal layers are removed from the upper nonmagnetic layer 602a and the lower nonmagnetic layer 602b as shown in FIG. 9(E) (a metal mask removal process).

Subsequently, as shown in FIG. 9(E), the respective depressed portions of the upper nonmagnetic layer 602a and the lower nonmagnetic layer 602b are filled with a magnetic material (colored black) and, in addition, an upper passivation layer 605a, an upper lubrication layer 606a, a lower passivation layer 605b and a lower lubrication layer 606b are stacked as shown in FIG. 9(F).

As described above, the processes of FIGS. 9(A) to 9(F) are performed with respect to the substrate 6 having patterns formed at the opposite sides thereof using the imprint apparatus shown in FIG. 1, thereby manufacturing a double-sided magnetic disk having the sectional structure as shown in FIG. 9(F).

Meanwhile, in FIGS. 9(A) to 9(F), a method has been described of manufacturing a magnetic disk from the media substrate 600 having the upper nonmagnetic layer 602a and the lower nonmagnetic layer 602b as shown in FIG. 9(A). However, a magnetic disk may be manufactured from a media substrate 600 having an upper magnetic layer made of a magnetic material and a lower magnetic layer made of a magnetic material instead of the upper nonmagnetic layer 602a and the lower nonmagnetic layer 602b. At this time, a dry etching process using the upper metal layer 603a and the lower metal layer 603b as a mask is performed with respect to the media substrate 600 in a state as shown in FIG. 9(C) to etch the magnetic bodies, and patterns are formed to a predetermined depth at the magnetic materials of the respective exposed portions of the upper magnetic layer and the lower magnetic layer (a magnetic layer patterning process). Subsequently, respective depressed portions of the upper magnetic layer and the lower magnetic layer are filled with a nonmagnetic material, thereby manufacturing a magnetic disk.

Also, in the above embodiment, the substrate 6, the upper mold 503a and the lower mold 503b are disposed in the imprint apparatus in a state in which the reference positions of the substrate 6, the upper mold 503a and the lower mold 503b are aligned with each other, and, as shown in FIG. 2, the center pin 30b having the first truncated conical pin tip end part P_{S1} and the second truncated conical pin tip end part P_{S2} is adopted. However, the shape of the tip end parts of the center pin 30b is not limited to the above truncated conical shape.

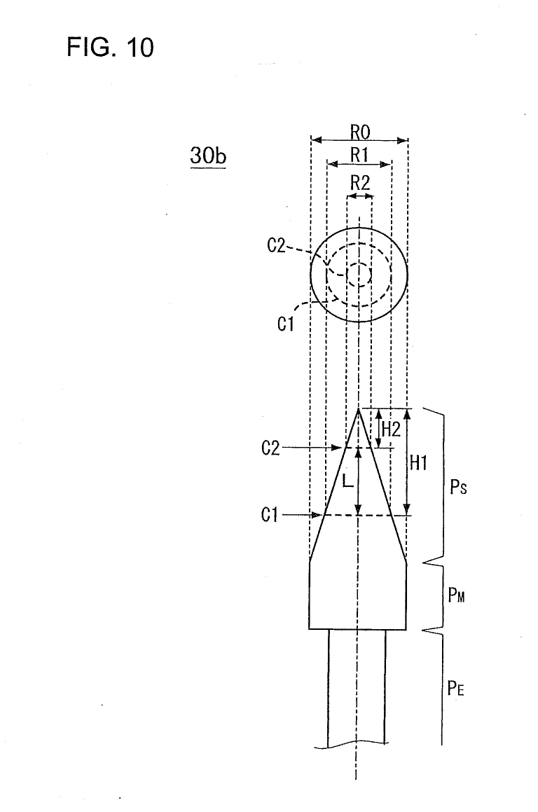

FIG. 10 is a view illustrating another shape of the tip end part of the center pin 30b.

The center pin 30b shown in FIG. 10 includes a cylindrical pin end part P_{E}, a cylindrical pin middle part P_{M} and a conical pin tip end part P_{S}. As shown in FIG. 10, the diameter R0 of the pin tip end part P_{S} at the bottom thereof, which is equal to the diameter of the pin end part P_{E}, is greater than the diameter R1 of the center holes provided at the center positions (the reference positions) of the upper mold 503a and the lower mold 503b. At this time, a first ring-shaped support part C1 to support the upper mold 503a and the lower mold 503b at the position distant from the peak of the pin tip end part P_{S} by a first distance H1 and a second ring-shaped support part C2 to support the substrate 6 at the position distant from the peak of the pin tip end part P_{S} by a second distance H2 are provided at the conical surface of the conical pin tip end part P_{S}. The diameter of the first ring-shaped support part C1 is equal to the diameter R1 of the center holes of the upper mold 503a and the lower mold 503b, and the diameter of the second ring-shaped support part C2 is equal to the diameter R2 less than the diameter R1, i.e., the diameter of the center hole of the substrate 6. Meanwhile, the distance L between the first ring-shaped support part C1 and the second ring-shaped support part C2 is greater than the thickness of the substrate 6.

Also, in the above embodiment, the tip end part of the center pin 30b is formed in a conical shape, and the substrate 6, the upper mold 503a and the lower mold 503b are supported by the center pin 30b in a state in which the center positions of the substrate 6, the upper mold 503a and the lower mold 503b are aligned with each other, to which, however, the present invention is not limited.

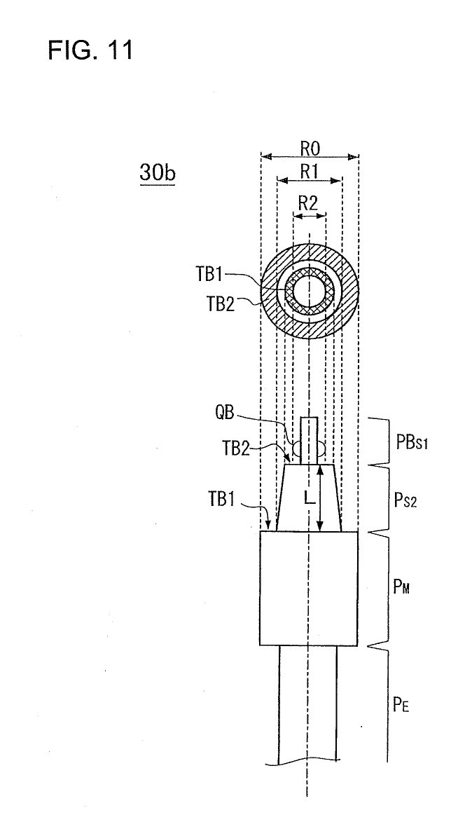

FIG. 11 is a view illustrating another example of the center pin 30b configured in consideration of the above points.

The center pin 30b shown in FIG. 11 is identical to the center pin 30b shown in FIG. 2 except that a first pin tip end part PB_{S1} is adopted instead of the first pin tip end part P_{S1} shown in FIG. 2.

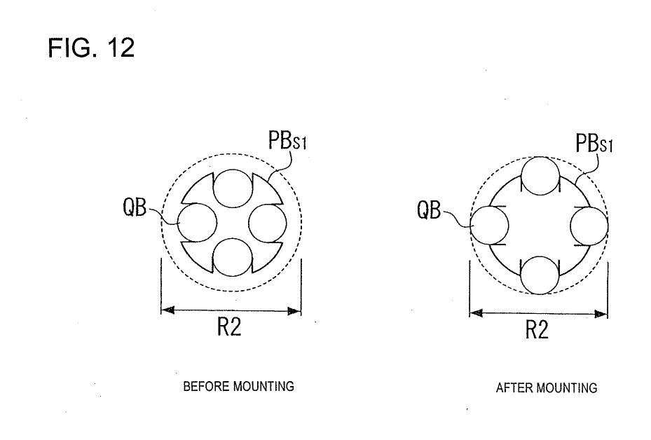

The first pin tip end part PB_{S1} shown in FIG. 11 is formed in the shape of a cylinder the diameter of which is smaller than the diameter R2 at the bottom and the top thereof. A plurality of (three or more) protrusion holes is formed at the side of the first pin tip end part PB_{S1} as shown in a see-through view showing the first pin tip end part PB_{S1} when viewed from the top thereof. Support balls QB to support the substrate 6 are provided in the respective protrusion holes. The diameters of the support balls QB provided in the respective protrusion holes are the same. In a state in which the substrate 6 is not mounted to the center pin 30b, the respective support balls QB do not protrude from the side of the first pin tip end part PB_{S1} as shown in FIG. 12. When the substrate 6 is mounted to the second support part TB2 of the center pin 30b, on the other hand, the pin center drive unit 507b blows compressed air into the first pin tip end part PB_{S1} with the result that the respective support balls QB protrude from the side of the first pin tip end part PB_{S1} as shown in FIG. 12. At this time, the center pin drive unit 507b blows compressed air into the first pin tip end part PB_{S1} so that the respective support balls QB protrude from the side of the first pin tip end part PB_{S1} at uniform intervals and with uniform force. By the respective support balls QB protruding from the side of the first pin tip end part PB_{S1}, the substrate 6 is supported by the center pin 30b in a state in which the center position (the reference position) of the substrate 6 is aligned with the center axis of the center pin 30b.

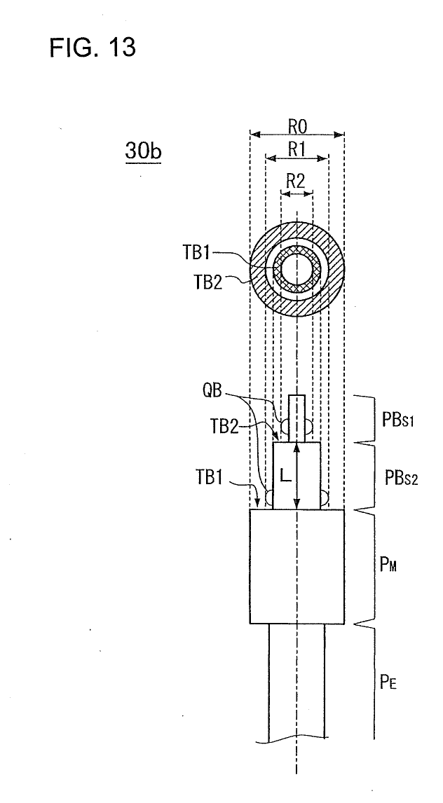

Meanwhile, the tip end parts of the center pin 30b may be configured to have a structure, as shown in FIG. 13, adopting the first pin tip end part PB_{S1} as shown in FIG. 11 and, in addition, a second pin tip end part PB_{S2} having the same function as the first pin tip end part PB_{S1} instead of the second pin tip end part P_{S2} as shown in FIG. 11. That is, in the center pin 30b shown in FIG. 13, the center positions (the reference positions) of the upper mold 503a and the lower mold 503b as well as the substrate 6 are aligned with the center axis of the center pin 30b by the support balls QB, thereby achieving alignment of the reference positions. In addition, in the above embodiment, the reference positions of the substrate 6, the upper mold 503a and the lower mold 503b are aligned with each other through the use of the support balls. However, support members may be formed in various other shapes than the ball shape so long as alignment of the reference positions of the substrate 6, the upper mold 503a and the lower mold 503b is achieved by the support members.

Meanwhile, in this embodiment, a description is given of the UV type imprint method and the UV type imprint apparatus, to which, however, the present invention is not limited. Other imprint methods, such as thermal imprint and energy ray (for example, light or X rays excluding UV) curable imprint, may be used. In the thermal imprint, it is possible to use a metal mold, such as a nickel mold, without using a transparent mold and, in addition, a member inserted as a transparent material which transmits UV rays to a resist may be replaced with a material, such as metal, which is not transparent.

Also, the upper layer part of the substrate 6 may be used as the transfer layer so long as the substrate 6 is made of a material, such as resin film, bulk resin, or low melting-point glass, which can transfer the uneven micro patterns formed at the molds. In this case, a transfer material may not be formed on the substrate 6 but a pattern may be directly transferred to the substrate 6. Also, the present invention may be used to manufacture various recording media, such as optical disks, in addition to a magnetic disk transfer.

1. A transfer method to press a first mold to a first surface of an object to which transfer is to be performed and to press a second mold to a second surface of the object, the transfer method comprising:
a first process of making the first mold supported by support means held by a first mold holding part;
a second process of aligning the first mold held by the first mold holding part and the second mold held by a second molding part by making the second mold supported by the support means held by the second mold holding part;
a third process of aligning said first and second molds and said object by making said object supported by said support means and making the first mold pressed to the first surface of the object supported by the support means; and
a fourth process of making the second mold pressed to the second surface of the object.

2. The transfer method according to claim 1, wherein
the first and second molds are supported by a first support part of the support means, and
the object is supported by a second support part located at a different position than the first support part of the support means.

3. The transfer method according to claim 2, wherein the diameter of the first support part of the support means is greater than the diameter of the second support part of the support means.

4. The transfer method according to claim 2, wherein
the support means comprises a conical tip end part, and
the first support part is located on a conical side of the tip end part at a position distant from the peak of the tip end part by a predetermined first distance, and the second support part is located on the conical side of the tip end part at a position distant from the peak of the tip end part by a second distance less than the first distance.

5. The transfer method according to claim 4, wherein the first support part and the second support part are spaced apart from each other by a distance greater than the thickness of the object.

6. The transfer method according to claim 4, wherein the first mold and the second mold are provided at reference positions thereof with center holes having a first diameter less than the diameter of the tip end part at the bottom thereof, and the object is provided at a reference position thereof with a center hole having a second diameter less than the first diameter.

7. The transfer method according to claim 1, wherein the fourth process comprises holding the object using the support means while making the first and second molds pressed to the object.

8. The transfer method according to claim 1, further comprising:
a fifth process of making the object and the first mold released from each other by making the first mold holding part move; and
a sixth process of making the second mold and the object released from each other by making the support means, by which the object is supported, move.

9. The transfer method according to claim 1, further comprising:
a seventh process of making the object to which a pattern has been transferred separated from the support means; and
an eighth process of supporting a new object to which transfer is to be performed using the support means, wherein
the third process comprises making the first mold pressed to the first surface of the object supported by the support means, and
the fourth process comprises making the second mold pressed to the second surface of the object.

10. A transfer apparatus to press a first mold to a first surface of an object to which transfer is to be performed and to press a second mold to a second surface of the object, the transfer apparatus comprising:
support means for supporting the object, the first mold and the second mold;
a first mold holding part for holding the first mold supported by the support means;
a second mold holding part for holding the second mold which is aligned with the first mold by being supported by the support means; and
a press drive means for making the first mold pressed to the first surface of the object which is aligned with said first and second molds by being supported by the support means and making the second mold pressed to the second surface of the object.

11. The transfer apparatus according to claim 10, wherein the support means comprises a first support part to support the first and second molds and a second support part to support the object, the first support part and the second support part being located at different positions.

12. The transfer apparatus according to claim 11, wherein the diameter of the first support part of the support means is greater than the diameter of the second support part of the support means.

13. The transfer apparatus according to claim 12, wherein
the support means comprises a conical tip end part, and
the first support part is located on a conical side of the tip end part at a position distant from the peak of the tip end part by a predetermined first distance, and the second support part is located on the conical side of the tip end part at a position distant from the peak of the tip end part by a second distance less than the first distance.

14. A transfer method to press a first mold having an uneven pattern at the surface thereof to one surface of a substrate to which transfer is to be performed and to press a second mold having an uneven pattern at the surface thereof to the other surface of the object substrate, the transfer method comprising:
a first holding process of making the first mold mounted on a center pin held by a first mold holding part by making the first mold holding part move in a first direction;
a first moving process of making the first mold holding part move in a second direction opposite to the first direction;
a second holding process of making the second mold mounted on said center pin held by said second mold holding part by making said center pin move in the first direction;
process of supporting the object of the support means;
a pressing process of making both surfaces of said substrate mounted on said center pin pressed by said first and second molds by making the first mold holding part move in the first direction;
a first releasing process of moving the first mold holding part in the second direction make the first mold and the substrate released from each other; and
a second releasing process of making the support means move in the second direction to make the second mold and the substrate released from each other.

15. A transfer method to make support means penetrate through holes formed at center positions of an object to which transfer is to be performed, a first mold and a second mold so that the object, the first mold and the second mold are aligned with each other, to press the first mold to a first surface of the object and to press the second mold to a second surface of the object, wherein
the center position of the object is aligned with the support means after the center positions of the first mold and the second mold are aligned with the support means.

16. A program, executable by a computer, to press a first mold to a first surface of an object to which transfer is to be performed and to press a second mold to a second surface of the object, the program being stored in a memory, the program comprising:
a first step of making the first mold supported by support means of a transfer apparatus held by a first mold holding part of the transfer apparatus;
a second step of making the second mold which is aligned with said first mold by being supported by the support means held by a second mold holding part of the transfer apparatus;
a third step of making the first mold pressed to the first surface of the object which is aligned with said first mold and said second mold by being supported by the support means; and
a fourth step of making the second mold pressed to the second surface of the object.

17. The transfer method according to claim 1, wherein the fourth process comprises, making said second mold pressed onto said second surface of said object while making said first mold pressed onto said first surface of said object.

18. A transfer apparatus to press a first mold having an uneven pattern at the surface thereof to one surface of a substrate to which transfer is to be performed and to press a second mold having an uneven pattern at the surface thereof to the other surface of the substrate, the transfer apparatus comprising:
first holding means for making the first mold mounted on a center pin held by a first mold holding part by making the first mold holding part move in a first direction;
first moving means for moving the first mold holding part in a second direction opposite to the first direction;
second holding means for making the second mold mounted on said center pin held by said second mold holding part by making said center pin move in the first direction;
pressing means for making both surfaces of said substrate mounted on said center pin pressed by said first and second molds by making the first mold holding part move in the first direction;
first releasing means for moving the first mold holding part in the second direction make the first mold and the substrate released from each other; and
second releasing means for making the support means move in the second direction to make the second mold and the substrate released from each other.

19. A transfer apparatus to make a center pin penetrate through holes formed at center positions of a substrate, a first mold and a second mold so that the substrate, the first mold and the second mold are aligned with each other, to press the first mold to a first surface of the substrate and to press the second mold to a second surface of the substrate, wherein
the center position of the substrate is aligned with the center pin after the center positions of the first mold and the second mold are aligned with the center pin.

20. A program, executable by a computer, to press a first mold having an uneven pattern at the surface thereof to one surface of a substrate to which transfer is to be performed and to press a second mold having an uneven pattern at the surface thereof to the other surface of the substrate, the program being stored in a memory, the program comprising:
a first step of making the first mold mounted on a center pin held by a first mold holding part by making the first mold holding part move in a first direction;
a second step of making the first mold holding part move in a second direction opposite to the first direction;
a third step of making the second mold mounted on said center pin held by said second mold holding part by making said center pin move in the first direction;
a fourth step of making both surfaces of said substrate mounted on said center pin pressed by said first and second molds by making the first mold holding part move in the first direction;
a fifth step of moving the first mold holding part in the second direction make the first mold and the substrate released from each other; and
a sixth step of making the support means move in the second direction to make the second mold and the substrate released from each other.

21. A program, executable by a computer, to make a center pin penetrate through holes formed at center positions of a substrate, a first mold and a second mold so that the substrate, the first mold and the second mold are aligned with each other, to press the first mold to one surface of the substrate and to press the second mold to the other surface of substrate, the program being stored in a memory, the program comprising:
a step of aligning the center position of the substrate with the center pin after performing an alignment of the center positions of the first mold and the second mold with the center pin.

22. A transfer method to press a first mold to a first surface of an object to which transfer is to be performed and to press a second mold to a second surface of the object, the transfer method comprising:
a first process of making the first mold supported by support means held by a first mold holding part;
a second process of making the second mold which is aligned with said first mold by being supported by the support means held by a second mold holding part;
a third process of making the first mold pressed to the first surface of the object which is aligned with said first mold and said second mold by being supported by the support means; and
a fourth process of making the second mold pressed to the second surface of the object.

23. A transfer apparatus to press a first mold to a first surface of an object to which transfer is to be performed and to press a second mold to a second surface of the object, the transfer apparatus comprising:
support means for supporting the object, the first mold and the second mold;
a first mold holding part for holding the first mold supported by the support means;
a second mold holding part for holding the second mold which is aligned with the first mold by making the second mold supported by the support means; and
a press drive means for making the first mold pressed to the first surface of the object which is aligned with said first and second molds by making said object supported by the support means and making the second mold pressed to the second surface of the object.
